(19) United States
(12) Patent Application Publication
(10) Pub. No.: US 2005/0029031 A1
(43) Pub. Date: Feb. 10, 2005

(54) Vehicle

(76) Inventor: Ralph M. Thomas, Ellijay, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 10/633,837

(22) Filed: Aug. 4, 2003

(51) Int. Cl. B62M 23/02

(52) U.S. Cl. 180/205

(57) ABSTRACT

A vehicle having multiple-wheel drive, wherein power is supplied by compact, lightweight hub motors located in each wheel hub, and wherein the hub motors are selectively controlled by a single throttle, and wherein the vehicle can operate between motorized, manually pedal-driven, and motor-assisted propulsion; and further has a multitude of operational modes such as hill-climbing, fuel efficient, and stealth modes.

### TECHNICAL FIELD

The present invention relates generally to vehicles, and more specifically to a multi-wheel drive vehicle having independent hub motors, wherein each hub motor is controlled by a single throttle, and wherein the vehicle is capable of alternating between multiple modes of operation.

### BACKGROUND OF THE INVENTION

As off-road driving continues to increase in popularity, riders continually place higher demands on their vehicle's performance. Snow, sand, mud, rocks and other rough terrain demands the increased traction and mobility of multiple-drive vehicles. As off-road motors become increasingly bigger and faster, having only one powered wheel subjects riders to extreme hazards, such as vehicle damage and/or personal injury. For professional riders, precious time is lost maneuvering around obstacles. Additionally, having only one powered rear wheel burdensomely requires that the rider maintain his or her weight on the rear wheel to preserve vehicle balance and improve overall off-road riding skills.

In an attempt to increase off-road vehicle performance, many riders typically equip their vehicles with large, wide, low-pressure rubber tires with an ample amount of tread. By utilizing a tire with a wider base, the surface area in contact with the ground is increased, thereby distributing the vehicle's weight over a greater area and allowing the vehicle to traverse over soft terrain such as sand, snow and mud. Moreover, enlarging the surface area in contact with the ground also results in greater friction between the tire and the ground, thereby increasing tire traction and overall vehicle performance. However, despite the advantages of wide all-terrain tires, most two-wheel vehicles, such as bicycles, mopeds and scooters, utilize relatively thin, conventional road tires. Due to the mechanical complexity of attaching a wheel that is wider than the axle of the vehicle's pedals, most two-wheel vehicles utilize wheels that are no wider than 2.5 inches, and thus, inherently fail to provide the advantages of wide all-terrain tires.

Numerous motors and propulsion systems have also been developed to increase off-road vehicle performance. Historically, motors have often been large and of relatively heavy weight. However, in order to keep the overall size and weight of the vehicle as low as possible, it is desirable to have a small and lightweight motor. As such, hub motors have now been developed to provide a lightweight propulsion system that requires minimal space, wherein such hub motors are built into the hubs of the vehicle, thereby taking advantage of and occupying an empty or open area of the vehicle not previously utilized. Placing motors in the wheel hubs also provides the vehicle with a low center of gravity and an equal distribution of weight thereover. Such a configuration is especially advantageous when driving a two-wheel vehicle or when operating a vehicle on rough terrain.

Despite the advantages of multiple-drive vehicles, hub-motored vehicles typically utilize a single hub motor, as employing multiple hub motors usually requires multiple throttle controls. Furthermore, most motorized vehicles have only one mode of operation, either on or off, and are not capable of alternating between hill-climbing, fuel efficient, and silent modes.

Therefore, it is readily apparent that there is a need for an off-road vehicle with multiple-wheel drive, wherein power is supplied by compact, lightweight hub motors located in each wheel hub, and wherein the hub motors are collectively controlled by a single throttle. Furthermore, there is a need for an off-road vehicle capable of alternating between multiple modes of operation, including hill-climbing, fuel efficient, and stealth modes.

### BRIEF SUMMARY OF THE INVENTION

Briefly described, in a preferred embodiment, the present invention overcomes the above-mentioned disadvantages and meets the recognized need for such a device by providing a multi-wheel drive vehicle having hub motors positioned within each wheel hub, wherein the hub motors are collectively controlled by a single throttle, and wherein the vehicle has multiple modes of operation, including hill-climbing, fuel efficient, and stealth modes.

According to its major aspects and broadly stated, the present invention in its preferred form is a multi-wheel drive vehicle having, in general, a frame, front wheel and rear wheels, pedal and drive assembly, throttle, and a motor controller.

More specifically, the present invention is a multi-wheel drive vehicle wherein the wheels each possess a hub motor and a wide all-terrain tire. Preferably, the vehicle can selectively change between motorized propulsion, as provided via the hub motors, manual propulsion, as provided via a manually driven pedal and drive assembly, or motor-assisted propulsion, as provided via the pedal and drive assembly and the hub motors. Should motorized propulsion be selected, the pedal and drive assembly is preferably partially folded away.

Preferably, a single throttle jointly controls the speed of all hub motors. Additionally, a motor controller protects the hub motors from over-current and over-heating, and further preferably enables the vehicle to alternate between various modes of operation and configurations of performance via selective regulation of the hub motors.

Accordingly, a feature and advantage of the present invention is its ability to alternate between various modes and configurations of performance.

Another feature and advantage of the present invention is its ability to alternate between motorized, manually-powered, and motor-assisted propulsion.

Another feature and advantage of the present invention is its ability to move the pedal and drive assembly into a partially folded position when motorized propulsion is selected.

Another feature and advantage of the present invention is its ability to operate under minimal power requirements due to the vehicle's compact size and light weight.

Another feature and advantage of the present invention is its multi-wheel drive capabilities utilizing multiple independent hub motors.

Another feature and advantage of the present invention is its ability to control multiple motors with a single throttle.

Another feature and advantage of the present invention is its use of wide all-terrain tires for better traction and increased vehicle performance.

Another feature and advantage of the present invention is its ease of use.

These and other features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Selected Alternate Embodiments with reference to the accompanying drawing figures, in which like reference numerals denote similar structure and refer to like elements throughout, and in which:

FIG. 1 is a perspective view of a vehicle according to a preferred embodiment of the present invention.

FIG. 2 is a partial cross-sectional view of a wheel assembly according to a preferred embodiment of the present invention.

FIG. 2A is a side view of a hub motor according to a preferred embodiment of the present invention.

FIG. 3 is a schematic illustration of the program flow of a motor controller according to a preferred embodiment of the present invention.

### DETAILED DESCRIPTION OF THE PREFERRED AND SELECTED ALTERNATIVE EMBODIMENTS

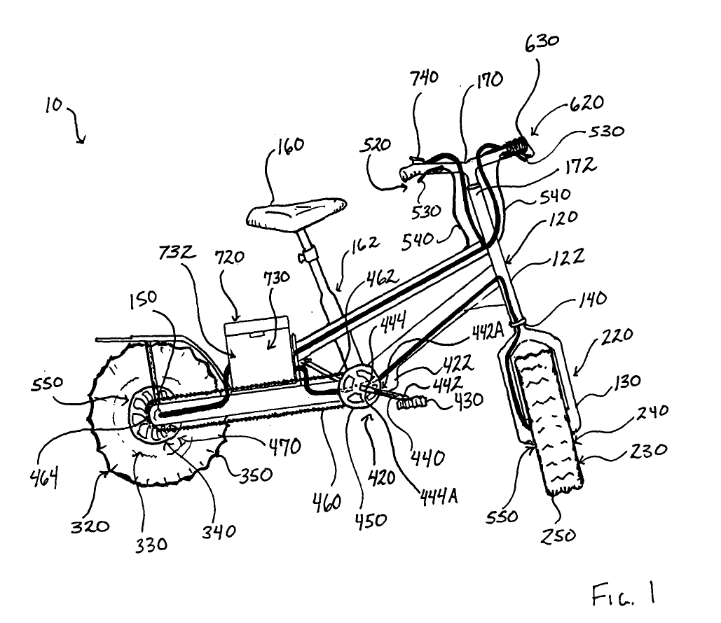

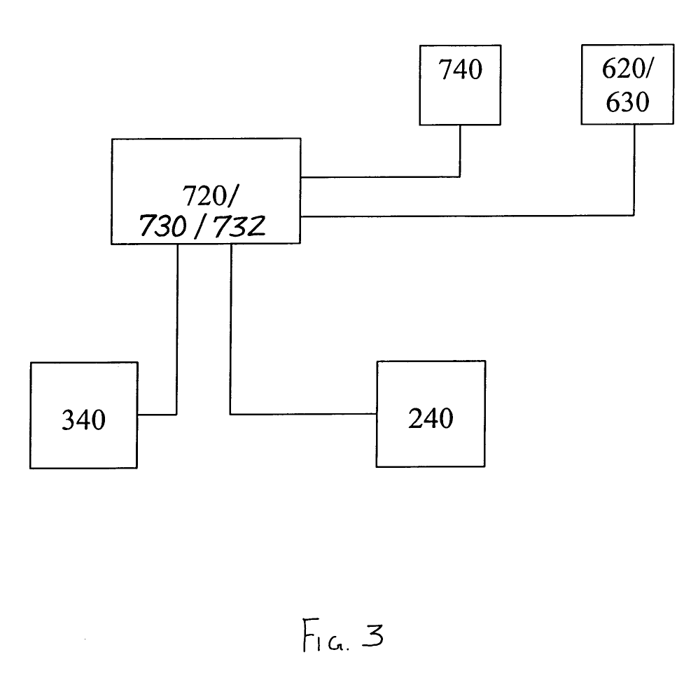

In describing the preferred and selected alternate embodiments of the present invention, as illustrated in FIGS. 1-3, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1-3, the present invention in a preferred embodiment is a vehicle 10 generally preferably possessing frame 120, front wheel assembly 220, rear wheel assembly 320, pedal and drive assembly 420, brakes 520, throttle 620, and motor controller 720. Although the preferred embodiment of vehicle 10 is in the form of a bicycle, it is contemplated in an alternative embodiment that vehicle 10 could be in the form of other vehicles, such as, for exemplary purposes only, mopeds, scooters, motorcycles, tricycles, four-wheelers, and the like.

Referring now more specifically to FIG. 1, frame 120 is preferably a conventional bicycle-type frame wherein front fork 130 is preferably steerably mounted on front portion 122 of frame 120 for steering vehicle 10. Preferably, front wheel assembly 220 is rotatably mounted on bottom portion 140 of front fork 130, and rear wheel assembly 320 is rotatably mounted on rear portion 150 of frame 120. As more fully described below, in order to equip vehicle 10 with all-terrain tires, bottom portion 140 and rear portion 150 are preferably configured and dimensioned to accommodate tires as wide as 7 inches; however, it should be recognized that bottom portion 140 and rear portion 150 could be dimensioned to accommodate any size and width of tire. Although it is preferred that vehicle 10 comprise front wheel assembly 220 and rear wheel assembly 320, it is contemplated in an alternate embodiment that vehicle 10 could comprise any suitable number of front and/or rear wheel assemblies. Preferably, frame 120 also includes seat 160, adjustably mounted to top portion 162 of frame 120, wherein includes seat 160, preferably functions to support the rider of vehicle 10. Handlebars 170 are preferably connected to top portion 172 of front fork 130 for allowing the rider to steer the vehicle in a selected direction. Additionally, preferably disposed on bottom portion 422 of frame 120 is pedal and drive assembly 420 for manually powering vehicle 10, as more fully described below.

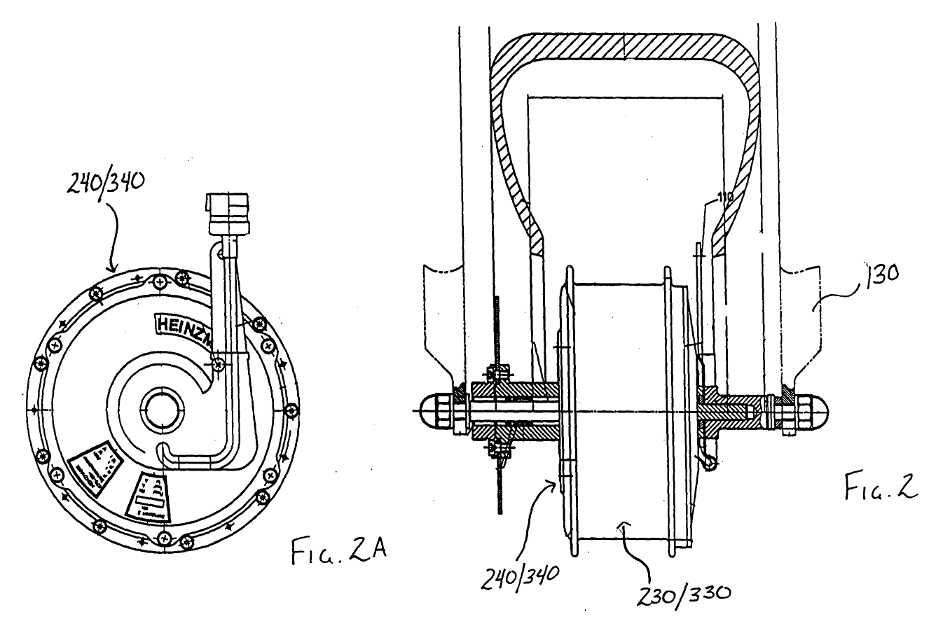

Referring now to FIGS. 2-2A, and with continued reference to FIG. 1, front wheel assembly 220 preferably comprises tire supporting rim 230, hub motor 240 and tire 250. Hub motor 240 is preferably a small, compact, conventional electric hub motor known with the art, wherein hub motor 240 is preferably mounted inside tire supporting rim 230 of front wheel assembly 220 via any suitable mounting means known within the art, such as, for exemplary purposes only, rivets, bolts, welding, and the like. It is contemplated that hub motor 240 could alternatively embody other suitable motors, so long as hub motor 240 functions to provide a torque force sufficient to rotationally drive supporting rim 230 of front wheel assembly 220 to propel vehicle 10 in a forward or reverse direction. Furthermore, hub motor 240 preferably possesses plastic gears for reducing the sound generated by the motor, as more fully described below.

Tire 250 is preferably a wide, low pressure, conventional all-terrain tire known with the art; however, it is contemplated in an alternative embodiment that any sized tire could be utilized. Preferably, tire 250 is mounted on tire supporting rim 230 of front wheel assembly 220, wherein tire 250 is formed from rubber and possesses an approximate width of 6 to 7 inches; however, it is contemplated in an alternative embodiment that tire 250 could be formed from any other suitable material and/or possess any desired width.

As further illustrated in FIGS. 2-2A, rear wheel assembly 320 preferably comprises tire supporting rim 330, hub motor 340 and tire 350, wherein tire supporting rim 330 is substantially identical to tire supporting rim 230, and wherein tire 350 is substantially identical to tire 250. Hub motor 340 is preferably substantially identical to hub motor 240, wherein hub motor 340 preferably utilizes metal gears to assist rear wheel assembly 320 in a hill-climbing mode, as more fully described below. Preferably, front wheel assembly 220 and rear wheel assembly 320 are substantially equal in size and dimension; however, it is contemplated in an alternate embodiment that front wheel assembly 220 and rear wheel assembly 320 could differ in size and dimension.

As an alternative to electric propulsion via hub motor 340, rear wheel assembly 320 could preferably be propelled by manual human-power. Preferably attached to the side of rear wheel assembly 320 is manual drive mechanism 470, wherein manual drive mechanism 470, in conjunction with pedal and drive assembly 420, preferably propels rear wheel assembly 320 via human pedal-power, as more fully described below. Although it is preferred that manual drive mechanism 470 be bolted to rear wheel assembly 320, it is contemplated in an alternate embodiment that any suitable attachment means known within the art be utilized, such as, for exemplary purposes only, rivets, machine screws, welding, and the like.

Pedal and drive assembly 420 preferably includes pedals 430, crank arms 440, pedal gear 450, chain 460 and manual drive mechanism 470, wherein pedal gear 450 is preferably rotatably mounted on bottom portion 422 of frame 120. Additionally, pedals 430 are preferably rotatably mounted to first end 442 of crank arm 440, wherein second end 444 of crank arm 440 is preferably permanently centrally affixed to pedal gear 450. Furthermore, first end 462 of chain 460 is preferably mounted around pedal gear 450, wherein second end 464 of chain 460 is preferably mounted around manual drive mechanism 470, and, as such, preferably results in chain 460 forming a continuous loop around pedal gear 450 and manual drive mechanism 470. Preferably, manual rotational movement of pedals 430 and crank arms 440 turns pedal gear 450 and moves chain 460 under and around manual drive mechanism 470, thereby rotating manual drive mechanism 470 and propelling rear wheel assembly 320 in a forward direction.

Crank arms 440 preferably possess hinges 442A for enabling the folding away of crank arms 440 and pedals 430 when not in use. Moreover, crank arms 440 preferably possess locking mechanisms 444A to securely maintain crank arms 440 and pedals 430 in a folded position, wherein locking mechanisms 444A are any suitable locking means, such as, for exemplary purposes only, straps, fasteners, screw locks, cam locks, stops, detents or the like. Furthermore, although hinges 442A are preferably utilized to hingably fold away crank arms 440 when not in use, it is contemplated in an alternate embodiment that other means of moving pedals 430 and crank arms 440 could be employed, such as, for exemplary purposes only, foldable pedals hinged at their point of connection with the crank arm, foldable crank arms hinged at their point of connection with the pedal gear, telescoping and retractable pedals and crank arms, removable pedals and crank arms, and/or removable pedals and/or crank arms.

Brakes 520 is preferably a conventional apparatus and system that allows the rider to reduce the speed of the vehicle, as is well known to those skilled in the art. Although it is preferred that brakes 520 be a cable pull system, it is contemplated in an alternate embodiment that brakes 520 could embody other suitable brake systems, such as, for exemplary purposes only, hydraulic or pneumatic brakes, pedal brakes, and the like. Specifically, brakes 520 preferably include brake controls 530, brake cable 540 and hub brakes 550, wherein brake controls 530 are brake levers disposed on handle bars 170. Although hub brake 550 is preferably mounted on each tire supporting rim 230 and 330, it is contemplated in an alternate embodiment that any number of hub brakes 550 could be utilized, such as, for exemplary purposes only, a single hub brake 550 mounted on tire supporting rim 330. Preferably, brake cable 540 is utilized to actuate hub brakes 550 via hand operation and engagement of brake controls 530.

Preferably, vehicle 10 further possesses throttle 620, wherein throttle 620 permits the rider to control the speed of the vehicle. Preferably, throttle 620 sends a signal to motor controller 720, wherein motor controller 720 controls the voltage and current available to hub motors 240 and 340, as more fully described below. Throttle 620 is preferably a cable pull system; however, it is contemplated in an alternate embodiment that throttle 620 could embody other suitable known throttle systems, such as, for exemplary purposes only, potentiometers or hall effect sensors, so long as the selected throttle jointly controls both hub motor 240 and hub motor 340. Preferably, throttle 620 possesses throttle control 630, wherein throttle control 630 is disposed on handle bars 170. Preferably, throttle control 630 is a twist grip throttle; however, it is contemplated in an alternate embodiment that throttle control 630 could embody other suitable known throttle controls, such as, for exemplary purposes only, thumb throttles, lever throttles, or switch throttles, so long as throttle control 630 is capable of jointly controlling both hub motor 240 and hub motor 340.

Preferably, vehicle 10 further possesses motor controller 720, wherein motor controller 720 preferably controls the voltage and current available to hub motors 240 and 340, thus controlling the power and speed thereof, as known within the art. Preferably, motor controller 720 comprises microchip 730, wherein microchip 730 is programmable for effectuating various modes and configurations of performance, and wherein microchip 730 protects hub motors 240 and 340 from over-current and over-heating. Additionally, vehicle 10 preferably possesses power source 732, preferably in the form of a battery or other similar transportable power source, wherein power source 732 preferably supplies the requisite operational power for hub motors 240 and 340.

Preferably, microchip 730 can further be programmed to accept instructions from the rider via throttle 620 and/or selector switch 740, wherein throttle 620 jointly controls the power and speed of hub motors 240 and 340, and wherein selector switch 740 is a user interface that alternates controller 720 between various modes of operation, as more fully describe below. Selector switch 740 is preferably a lever switch disposed on handle bars 170; however, it is contemplated in an alternate embodiment that selector switch 740 could embody other suitable switch mechanisms accessible to the rider, such as, for exemplary purposes only, thumb switches, joystick switches, grip handle switches, or the like.

In a preferred embodiment, motor controller 720 is capable of switching between normal mode, wherein equal power is available to hub motor 240 and hub motor 340; hill-climbing mode, wherein all power is sent to hub motor 340; stealth mode, wherein all power is sent to hub motor 240; and, fuel efficient mode, wherein power allocation is configured by microchip 730 for maximum performance. When in stealth mode, vehicle 10 is configured for minimal noise, as the louder metal gears of hub motor 340 are preferably deactivated, and wherein the silent plastic gears of hub motor 240 are preferably activated. Stealth mode may be particularly important when vehicle 10 is driven off road for hunting activities, as animals will typically flee from otherwise loud engine noise. It is recognized that motor controller 720 could be capable of alternating between other useful modes of operation, such as, for exemplary purposes only, hill-descending mode, enhanced speed modes, turbo modes, idle mode, and/or the like.

As previously discussed, although the preferred embodiment of vehicle 10 is in the form of a bicycle, it is contemplated in an alternative embodiment that vehicle 10 could embody other vehicles such as mopeds, scooters, motorcycles, tricycles and/or four-wheelers.

In another alternate embodiment, vehicle 10 could have any suitable number of front wheel assemblies 220 and any number of rear wheel assemblies 320.

In another alternate embodiment, front wheel assembly 220 and rear wheel assemblies 320 could differ in size, dimension, power, tire size, torque, etc.

In another alternate embodiment, vehicle 10 could have any number of seats 160.

In another alternate embodiment, vehicle 10 could have multiple sets of pedals 430, or eliminate pedal and drive assembly 420 entirely.

In another alternate embodiment, vehicle 10 could utilize conventional road tires instead of all-terrain tires 250.

In another alternate embodiment, handle bars 170 could be replaced by a steering wheel or a joystick.

In still another alternate embodiment, vehicle 10 could possess shocks.

In yet another alternate embodiment, vehicle 10 could possess any number of headlights, taillights and turn-signals.

In still another alternate embodiment, vehicle 10 could possess a sidecar and/or rear buggy.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

1. A multiple-wheel drive vehicle, comprising:
at least one front-wheel assembly;
at least one rear-wheel assembly;
first means for driving said at least one front-wheel assembly, said first drive means carried by said at least one front-wheel assembly;
second means for driving said at least one rear-wheel assembly, said second drive means carried by said at least one rear-wheel assembly; and
means for controlling said first drive means and said second drive means.

2. The vehicle of claim 1, wherein said first drive means and said second drive means each are hub motors.

3. The vehicle of claim 2, wherein said controlling means is a microchip programmed to determine the amount of current needed for each of said hub motors based on a user interface means for input.

4. The vehicle of claim 3, wherein said input means is a twist-grip throttle.

5. The vehicle of claim 3, wherein said input means is a lever throttle.

6. The vehicle of claim 1, further comprising a pedal assembly, wherein said pedal assembly is capable of propelling said vehicle via human pedal-power.

7. The vehicle of claim 6, wherein said pedal assembly is foldable

8. A multiple-wheel drive vehicle, comprising:
at least one front-wheel assembly;
at least one rear-wheel assembly;
first means for driving said at least one front-wheel assembly, said first drive means carried by said at least one front-wheel assembly;
second means for driving said at least one rear-wheel assembly, said second drive means carried by said at least one rear-wheel assembly;
means for controlling said first drive means and said second drive means; and
means for selecting between at least two modes of operation, wherein said at least two modes of operation is selected from the group consisting of an all-wheel mode, a single-wheel assembly mode, a normal mode, a hill-climbing mode, a stealth mode, an enhanced-speed mode, an idle mode, a hill-descending mode, a front-wheel drive mode and a rear-wheel drive mode.

9. The vehicle of claim 8, wherein said first drive means and said second drive means each are hub motors.

10. The vehicle of claim 9, wherein said controlling means is a microchip programmed to determine the amount of current needed for each of said hub motors based on a user interface means for input.

11. The vehicle of claim 10, wherein said input means is a twist-grip throttle.

12. The vehicle of claim 10, wherein said input means is a lever throttle.

13. The vehicle of claim 8, further comprising a pedal assembly, wherein said pedal assembly is capable of propelling said vehicle via human pedal-power.

14. The vehicle of claim 13, wherein said pedal assembly is foldable.

15. A method for propelling a two-wheeled vehicle, comprising the steps of:
a. adapting a first hub motor to a first front wheel;
b. adapting a second hub motor to a second rear wheel; and
c. controlling the power or speed of each of said first and second hub motors via a single user interface input.

16. The method of claim 15, further comprising the step of selecting a desired mode, wherein said desired mode is selected from the group consisting of an all-wheel mode, a single-wheel assembly mode, a normal mode, a hill-climbing mode, a stealth mode, an enhanced-speed mode, an idle mode, a hill-descending mode, a front-wheel drive mode and a rear-wheel drive mode.
